(19) United States
(12) Patent Application Publication
(10) Pub. No.: US 2009/0259567 A1
(43) Pub. Date: Oct. 15, 2009

(54) System and Apparatus for Creating Customized Artwork at Point-of-Purchase

(76) Inventor: Kimberly Watts, Milwaukee, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/101,907

(22) Filed: Apr. 11, 2008

(51) Int. Cl. G06Q 30/00

(52) U.S. Cl. 705/27

(57) ABSTRACT

A method and apparatus creating customized artwork for a customer at a point of purchase which includes a display and user interface adapted for a point-of-purchase capable of creating layered images, and allowing a user to update the layered images and specify options for creating customized artwork printed on a specified canvas format.

### FIELD OF THE INVENTION

This invention relates generally to the field of home decor, and more specifically to a method and system for creating customized artwork which conforms to a color scheme.

### BRIEF DESCRIPTION OF THE DRAWINGS

FIG. 1 is a flow chart of a method for creating customized color at point-of-purchase artwork from a database of images.

FIG. 2 is a flow chart of a method for creating customized color artwork at point-of-purchase which includes associating a customized user image with an image price.

FIG. 3 is a flow chart of a method for creating customized color artwork at point-of-purchase which includes optimizing or re-optimizing a color palette based on an executed user selection.

FIG. 4 is a flow chart of a method for creating customized color artwork at point-of-purchase which includes selecting and applying effects.

FIG. 5 is a flow chart of a method for creating customized color artwork at point-of-purchase which further includes tracking order status information.

FIG. 6 is a flow chart of a method for creating customized color artwork at point-of-purchase which allocates revenue to revenue recipients.

FIG. 7 illustrates one embodiment of an apparatus for creating customized color artwork at point-of-purchase.

### BACKGROUND

Consumers spend approximately seven percent (7%) of their disposable income on home furnishings and home decorating each year. Large retail hardware and furniture stores have penetrated global and consumer markets and are located in most suburbs. Hardware and large retail stores attract repeat customers which may be educated as to inventory and services which may be purchased in the store. In contrast, furniture and art stores are often located at a distance from shopping malls, and attract only customers contemplating specific purchases. Many consumers seek to update their surroundings by purchasing inexpensive artwork, and do so with budgetary concerns and the need to have a piece which “fits” into their space and color scheme, rather than a desire for an original or costly piece.

Often, the primary motivating factor for purchasing art (e.g., a poster, prints and/or mass produced paintings) is the desire to fill wall space, rather than an appreciation for the artist or novelty of a particular piece.

Consumers are often selective in choosing home décor items to be placed on a wall, and do so with five primary criteria in mind: cost, color, subject matter, size and geometric proportions. Additional factors include exposure and proximity to point-of-purchase. Customers often very critically evaluate the color of an item to determine how it will blend into their home décor.

Subject matter is an additional factor for consumers in selecting artwork. Artwork is also an item which consumers use to express their individuality, personalities and style preferences. Consumer tastes vary from traditional to abstract and contemporary selections, and also as to choice of subject matter.

Size and shape is yet another factor influencing consumer choice at the point of purchase. A consumer must decide whether the particular piece will geometrically complement their wall space.

The need for a consumer to find a piece of artwork having cost, color, subject matter, size and geometric proportions are statistically limiting factors in offering inventoried items appealing to consumer tastes.

It is desirable to have a system and method for economically customizing artwork at the point of purchase, taking into account consumer preferences related to cost, color, subject matter, size and geometric proportions.

It is also desirable to appeal to a wide variety of consumer tastes and customer preferences without the need to carry large amounts of inventory.

It is further desirable to develop a method and system for offering customized artwork to consumers at high-traffic retail locations which is designed to be offered at such locations and which consumers visit repeatedly, and which may complement existing product lines (such as paint and fabrics) and at which they may choose to make an impulse purchase.

### GLOSSARY

The following are terms used in connection with the system and method for a system of creating customized color artwork described herein:

As used herein, the term “layer” means a graphical element or object having one or more image components which may be combined (“stacked”) one on top of another to create an overall image. Each component in the layer may have display characteristics such as color, hue, brightness, saturation, opacity, contrast and any other effect or combination of effects which may be produced by standard or customized graphics software. For an adjustable layer, when one component of the layer is manipulated, the remaining components are adjusted in a proportional or related manner.

As used herein, the term “layered image” means an image made up of one or more layers which may be adjustable or permanent color layers.

As used herein, the term “orientation” refers to the way in which a customized user image is oriented for viewing. Several types of orientation may be offered as selections on a user menu. Portrait rectangle is an orientation type in which the height of the image is greater than the width of the image. Landscape orientation is an image in which the width of the image is greater than the height. Square orientation is an image for which height and width are equal. A further type of orientation may include tile orientation in which an image is loaded onto multiple small image surfaces to be mounted on a single wall space. A tile orientation may incorporate multiple portrait rectangle, landscape rectangle or square components. Orientation types may be selected from an orientation menu.

As used herein, the term “image database” generally refers to a data base of images capable of being modified by making color selections from a selection of available colors (a color palette) and effects. Images contained within the image database may be specially created and customized for use in a method or software program, or may be images created using photographic or replicating technologies (e.g., to replicate a painting), or may be scanned or imported images or photographs. Images may be stored in any proprietary or non-proprietary software format known in the art. As used herein, an image database is generally capable of being searched or modified.

As used herein, the term “customized user image” means a completed image that has been modified (or created from predefined components) based on selections from menus offering choices in subject matter, size, image type, orientation, color, canvas selection, printable image components, effects or any combination thereof.

As used herein, the term “image category” generally refers to a group of images having a common characteristic such as subject matter, style, color scheme, price and/or size.

As used herein, the term “category menu” generally refers to a menu of image category choices.

As used herein, the term “color swatch” or “swatch” generally refers to a visual or graphical representation of a combination of pixels which may display a specific color or shade, and/or which may illustrate a graphic effect applied to a color (e.g., to give a multi-dimensional effect or a hue, opacity or brightness).

As used herein, the term “adjustable layer” generally means a layer with one or more areas that may be altered by selecting a color swatch or an effect. An adjustable layer may include multiple areas of an image which may be altered by a single color swatch or effect selection. For example, in an outdoor scene image, a user may select a color swatch to determine the color of a main image, and the color of various corresponding details or sections may change simultaneously. The use of an adjustable layer allows the color, hue, saturation and brightness of many areas of an image to be simultaneously and proportionately altered (e.g., may maintain a constant color, hue, saturation and brightness relationship to each other). Multiple adjustable layers may be used to create a customized user image. An adjustable layer can be specifically correlated to a color swatch.

As used herein, the term “permanent layer” generally means a layer with color areas that cannot be altered.

As used herein the term “color scheme” means a preselected combination of colors. A user may select among several color schemes or single swatch or single menu option. When selecting a color scheme option, a user may be manipulating several adjustable layers at once.

As used herein the term “effect” or “special effect” means a graphic effect applied to an image, area of an image, or an image layer. Effects include but are not limited to 3-D simulation, scan lines, lightning and lighting effects, explosions, fire, complex signatures, terrains, clouds, glass, blurring, sharpening, texturizing, creating a mosaic effect, adjusting hue, adjusting saturation, adjusting brightness, opacity, creating the appearance of fabric or other texture, creating a shadow effect, creating a water color effect, color layering and overlays, color transparencies or any other graphic effect known in the art to alter or customize the appearance of a color area or image. Other effects may include effects to emulate oil paint applied by brush, spatula or tube application, or water color brush strokes. Effects may further include emulation of pen, crayon, pencil sketch, charcoal, airbrush or a conté drawing medium. A single special effect may also be created by any combination of one or more effects identified herein. Effects may also include hand finishing effects such as adding layers or brush strokes. Effects may further include a process of electronically matching a color of a user supplied product or material (e.g., paint color) and including the color within a swatch or color scheme.

As used herein the term “effect menu” means a list of effects or special effects displayed on a user interface, from which a user may select to apply an effect to an identified area or layer of an image, or to an image in its entirety, to customize all or a portion of an image.

As used herein, the terms “master palette” generally refers to all colors appearing in a color scheme prior to selection of a first swatch by a user.

As used herein, the term “optimized color palette” means a subset of colors identified within a master palette, said subset being defined by limiting criteria including but not limited to elimination of colors which cannot be visually differentiated from each other thus conflicting with each other (e.g., “color conflicts”). Other exemplary limiting criteria for creating may include or be based on contrast, intensity, opacity, hue, saturation, RGB factors, brightness or other factors which may be used to identify colors for inclusion within an optimized color palette based on a selection of a color swatch by a user.

As used herein, the term “re-optimized color palette” means a subset of colors identified within an already optimized palette, said subset being defined by limiting criteria including but not limited to contrast, intensity, opacity, hue, saturation, RGB factors, brightness or other factors which may be used to identify colors for inclusion within an optimized color palette based on a second or subsequent selection of a color swatch by a user which modifies the colors previously appearing in an optimized or re-optimized color palette.

As used herein, the term “canvas” or “canvas option” may include printable material capable of displaying a customized user image including but not limited to universal matte canvas, fabric, wallpaper, poster board, paper, laminate, film or transparent film. It may also have an adhesive backing or any other material known in the art.

As used herein, the term “framing option” means mounting a canvas without the use of a frame, use of a matting technique, a particular style of frame, a size or dimension of frame, a frame color, a finish on a frame or a material from which a frame may be constructed. Framing options may be selected from a menu on a user interface.

As used herein, the term “point-of-purchase” means retail, online and other consumer sales through any channel potentially capable of reaching consumers including wholesale, retail and Internet outlets. Examples of a point of purchase would be a retail store, display within a store, kiosk, web site, wholesale outlet, booth or any combination thereof.

### DETAILED DESCRIPTION OF DRAWINGS

For the purpose of promoting an understanding of the present invention, reference will be made to multiple embodiments of a system and apparatus for creating customized color artwork at a point-of-purchase. It is to be understood, however, that the present invention may be embodied in various forms. For example, elements and components of a system may be presented in varying manners, or steps of a method may be performed in a different order, and such representations are to be considered purely exemplary and representational of the elements or components which comprise the entire system, and not definitive of the order in which such components or elements perform a designated function.

Acts and symbolically represented operations or instructions may, but are not required to, include the manipulation of electrical or biological signals (such as a touch pad) by a CPU. Therefore, specific details and representations disclosed herein are not to be interpreted as limiting, but rather as a basis for the claims and as a representative basis for teaching one skilled in the art to employ the present invention. One of ordinary skill in the art will readily appreciate that modifications do not depart from the spirit and scope of the present invention, some of which are mentioned in the following description.

With particular reference to the figures, the reader should also know that like numerals in different figures may refer to the same elements of the embodiments. Moreover, it should be noted that each embodiment of the invention is not depicted by the figures.

Data and images may be maintained on a computer readable medium including magnetic disks, optical disks, organic memory, and any other volatile (e.g., Random Access Memory (“RAM”)) or non-volatile (e.g., Read-Only Memory (“ROM”)) mass storage system readable by a CPU. The computer readable medium includes cooperating or interconnected computer readable media, which exist exclusively on the processing system or can be distributed among multiple interconnected processing systems that may be local or remote to the processing system or may be maintained by an outside entity or source.

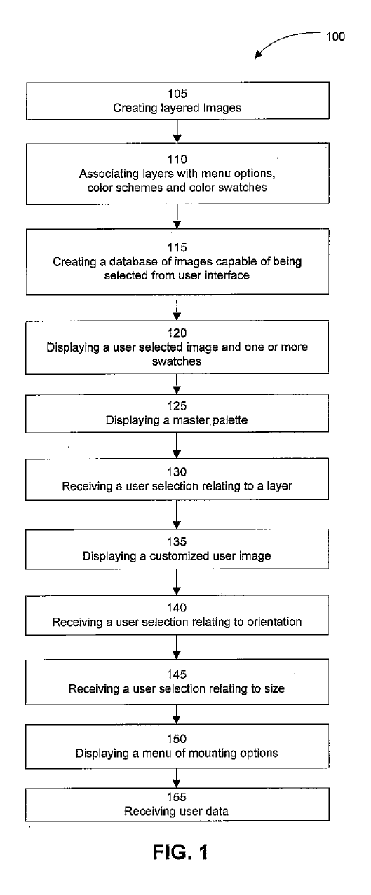

FIG. 1 is a flow chart of Method 100 for creating customized color artwork from an image database. The images in the image database may be scanned, downloaded or otherwise imported into the database. The images may further include images which are specially created and customized for use with Method 100 (e.g., layered images as discussed infra.), or may be images which may be created from photographic or replicating technologies (e.g., to replicate a painting) or may be photographs. The images may be stored in any proprietary or non-proprietary software format known in the art, or created for the purpose of storing and retrieving images to allow Method 100 to be performed. An image may also include individual design templates and graphic components which the user can manipulate to create their own custom image. The images in the image database may also include licensed images. Additionally, in some embodiments, an image database may include a user supplied image that temporarily becomes part of the database and is only accessible to a particular user.

FIG. 1 includes Step 105, of creating layered images. Layered images are images made up of one or more layers which may be adjustable or permanent color layers. A layer is a graphical element or object having one or more image components which may be combined (“stacked”) to create the completed image overall image. Each component in the layer may have display characteristics such as color, hue, brightness, saturation, contrast and other effects. For an adjustable layer, when one component of the layer is manipulated, the remaining components are adjusted in a proportional or related manner.

An image will have at least one adjustable layer and/or at least one permanent layer. Adjustable and permanent layers may be created when an image contained within the database is created, or they may be created or associated with an existing image. Additionally, adjustable and permanent layers may be created in an existing image (e.g., a scanned or imported image) by assigning values to various color, gray-scale and/or black-and-white images in an existing image imported into the system, and using the assigned values to assign corresponding colors to areas within an adjustable layer or permanent layer. A layer is simply one image component which may be stacked or combined with one or more other layers to form a completed image. In one exemplary embodiment, a layer may include a yellow circle and blue square. A second layer may have a red triangle and smaller white square. By placing the second layer on top of the first, an image may be created of a house having a triangular roof, rectangular body, a small white “window” and a yellow circle representing a sun. If the second layer is adjustable, adjusting the sun to have an orange hue, will cause the window to appear red.

An adjustable layer generally means at least one area within an image that may be altered by selecting a color swatch, a color scheme from a menu or other program option. An adjustable layer may include multiple areas of an image which may be altered by a single color swatch or effect selection to change the color of various corresponding details or sections (background foliage) may change simultaneously. The use of an adjustable layer allows the color, hue, saturation and brightness of many areas of an image to be simultaneously and proportionately altered (e.g., may maintain a constant color, hue, saturation and brightness relationship to each other). Multiple adjustable layers may be used. An adjustable layer can be specifically correlated to a color swatch. Generally, a color swatch will represent the color shown on a main or visually dominant color area within a layer, but may be correlated to any color area within a layer.

An image may also include one or more permanent layers which contain colors that are not altered by selecting color swatches. The colors remain constant despite user selections executed and alteration of color schemes which effect the adjustable layers.

Method 100 further includes Step 110 of associating adjustable and permanent layers with menu options, color schemes, color swatches. Color swatches represent one area of color in a layer, and clicking on a swatch brings up a selection of alternative colors (called palettes, as discussed infra.) from which a user may select to alter the color areas (i.e., components with color) within an adjustable layer. Color areas will be adjusted in a constant ratio to each other. For example, in the embodiment described above, if the second layer is adjustable, adjusting the sun to have an orange hue, will cause the window to appear red. Other features and effects such as brightness and saturation may be altered in a constant ratio as well, as may be a mix or ratio of particular pixels which create the visual effect or color selected by a user.

Also shown in Method 100, as shown in FIG. 1, is Step 115 of creating a database of images capable of being selecting from user interface from which a user may select an image. An image database may include images organized within image categories that may be selected by a user from a category menu. The database of images may be associated with a category (e.g., subject matter of the image such as “impressionistic,” “abstract,” traditional,” “nature scenes,” “objects,” “people,” youth,” and “floral”). The image categories displayed on the category menu may be pre-determined or selected from a list of categories included with a software program created to carry out Method 100. Additional categories may be created from user provided or imported images.

Also shown in FIG. 1 is Step 120, of displaying a user selected image and one or more color swatches on a user interface which represents a color corresponding to a color area on an associated layer. The color swatches correspond to a master color palette which is an interface from which a user may view and select all colors available for the color area. A swatch is representative of one color area appearing on an adjustable layer and/or permanent layer in a color scheme, which corresponds to a color palette representing selections to alter the adjustable layer. One or more swatches may be displayed beneath a customized user image on a user interface.

As shown in FIG. 1, when a first swatch is selected, Step 125 is performed, and consists of displaying a master palette which is a selection of colors displayed on an updated user interface, and which contains all colors corresponding to a swatch appearing below a user selected image. A swatch, representative of one color appearing on an adjustable layer and/or permanent layer in a color scheme, corresponds to a color palette representing selections to alter the adjustable layer.

Method 100 further includes Step 130 of receiving a user selection relating to a layer from a master palette, displaying updated swatches (corresponding to the user selection, which may or may not change in relation to the user selection). In alternative embodiments of Method 100, menu options may be used instead of swatches, and may be selected from a menu of color schemes.

FIG. 1 further illustrates Step 135 of displaying a customized user image. After a user option has been selected, an updated user image will be displayed reflecting the user selections. Various embodiments of the invention may allow the user to approve or further alter the image.

Method 100, as shown in FIG. 1, further includes Step 140 of receiving a user selection relating to an orientation from a menu of orientation options, including but not limited to portrait rectangle, landscape, square and tile. Portrait rectangle is an orientation in which the height of the image is greater than the width of the image. Landscape orientation is an image in which the width of the image is greater than the height. Square orientation is an image for which height and width are equal. A further type of orientation may include tile orientation in which an image is loaded onto multiple small image surfaces to be mounted on a single wall space. A tile orientation may incorporate multiple portrait rectangle, landscape rectangle or square components.

Method 100 further includes Step 145 of receiving a user selection relating to a size. The user selection may be selected from a menu of size options and ranges. Exemplary size offerings may include (in inches) 12×12, 12×18, 24×24, 24×36 and 36×54. However, size options are not limited to any range or dimension, other than the capability of the printing device or availability of canvas and media corresponding to a user selection.

FIG. 1 further includes Step 150 of displaying a menu with options on a user interface. Framing and mounting options include but are not limited to selecting the canvas (printable material) for the image to be printed, selecting framing options and selecting a canvas finish (e.g. matt, satin or faux), selecting a frame option (style, size, material and finish. A printable material may be canvas, transparent sheeting (with or without an adhesive backing), paper, poster, fabric, carpeting wallpaper or any other material capable of receiving and reproducing a printed image.

FIG. 1 further includes Step 12 of receiving user data. This information may include user-identifying information (e.g., name, address, phone number or credit card information) and it may also include information regarding the delivery or pick-up method by which a user will receive a completed, mounted image corresponding to their previously executed user selection. User data may also include a delivery protocol such as shipping, drop-shipping, pick-up upon completion or any other manner in which a user might receive the completed, mounted image. The user information may be stored or retained, and various embodiments of this invention may have alternative methods, databases and software protocols for receiving and/or storing user information. User data may include any information relevant to a user.

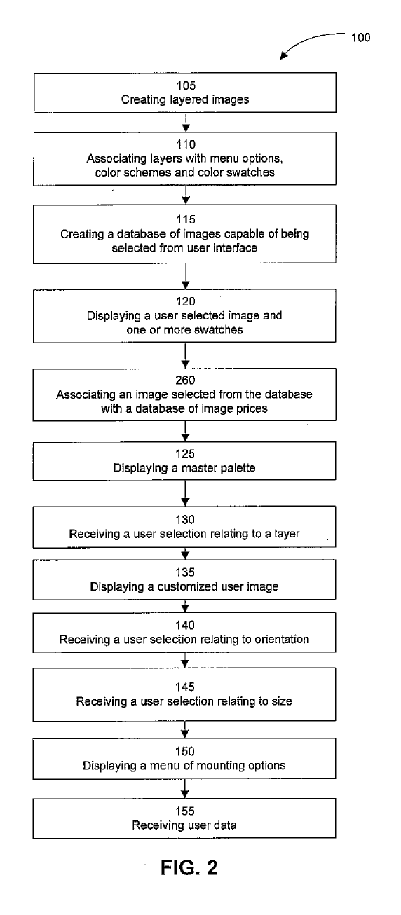

FIG. 2 illustrates a further embodiment of Method 100 further including Step 210 of associating an image selected from the database of images with a database of image prices. Image price may include or correlate various components such as the cost assigned to the materials, correlating the size option selected by the user, assigning a price to a framing option selected, shipping, sales tax, fixed and variable overhead, commission, a variable rent charge for store or kiosk space, premiums and incentives, coupon promotions, promotions or discounts based on concurrent purchase of other items or any other charge known in the retail or wholesale industry. The image prices reflected may include a licensing fee for a licensed image. Specific pricing may also be associated with components, features or options which the use may select for manipulating, creating or altering an image.

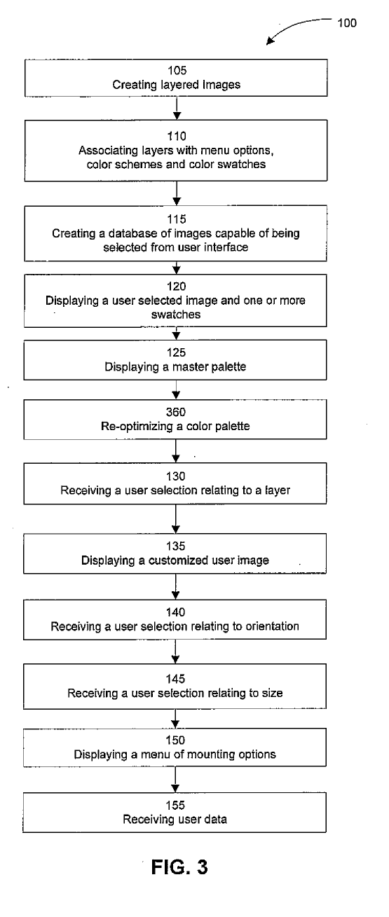

FIG. 3 illustrates a further embodiment of Method 100 including Step 310 of re-optimizing a color palette. This step includes creating a new color palette based on a previous user selection made from one or more color palettes. An optimized color palette may be further modified with one or more selection areas after a second user selection has been made to create a re-optimized palette offering different color selections for other areas. For example, in a drawing of a flower, if a color is selected for a petal, the optimized color palette for stem area may be re-optimized to include colors complementary or otherwise desirable in view of the previous selections for adjacent and other color areas.

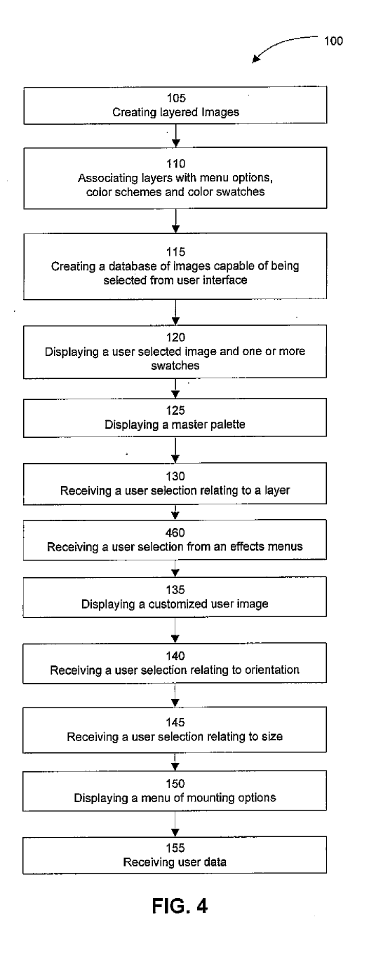

FIG. 4 illustrates a further embodiment of Method 100 including Step 410 of receiving a user selection from an effects menu, the effects including but not limited to 3-D simulation, scan lines, lightning and lighting effects, explosions, fire, complex signatures, terrains, clouds, glass, blurring, sharpening, texturizing, creating a mosaic effect, adjusting hue, adjusting saturation, adjusting brightness, creating the appearance of fabric or other texture, creating a shadow effect, creating a water color effect, color layering and overlays, color transparencies or any other graphic effect known in the art to alter or customize the appearance of a color area or image.

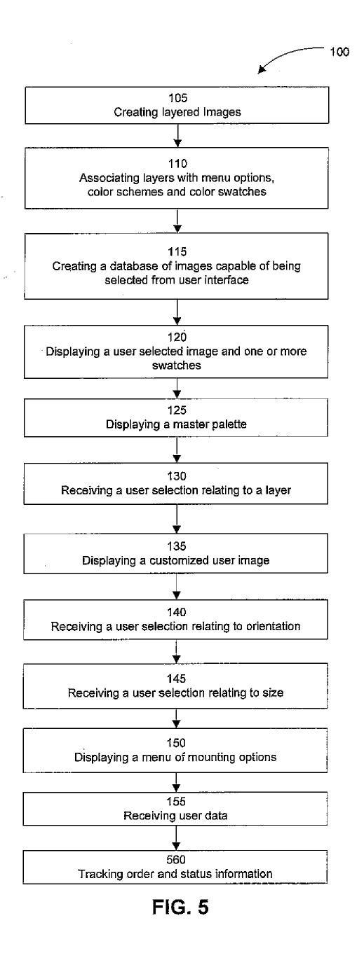

FIG. 5 illustrates a further embodiment of Method 100 including Step 510 of tracking order status (e.g., manufacturing progress, transit and shipping information and return status). Other embodiments may include a user interface which corresponds with a password to enable a user to check the status of an order. This step may be coordinated with drop-shipping, off-site manufacturing and other options.

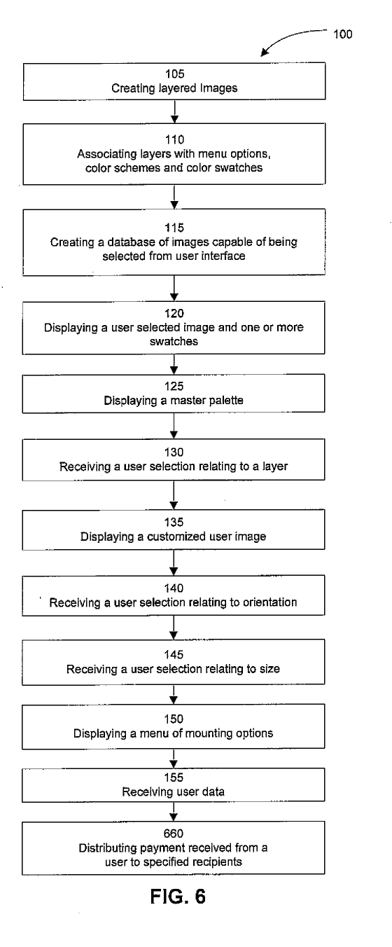

FIG. 6 illustrates a further embodiment of Method 100 including Step 610 of distributing payment received from a user to specified revenue recipients, which may include commission sales people, distributors, shippers, manufacturers, vendors or any person(s) or entities entitled to receive a portion of proceeds from the sale of a customized user image. For example, in one embodiment, Method 100 may be performed in a retail setting, such as a hardware store. A revenue retail vendor may be a revenue recipient entitled to a fee for permitting a kiosk or other facility to be located in the store.

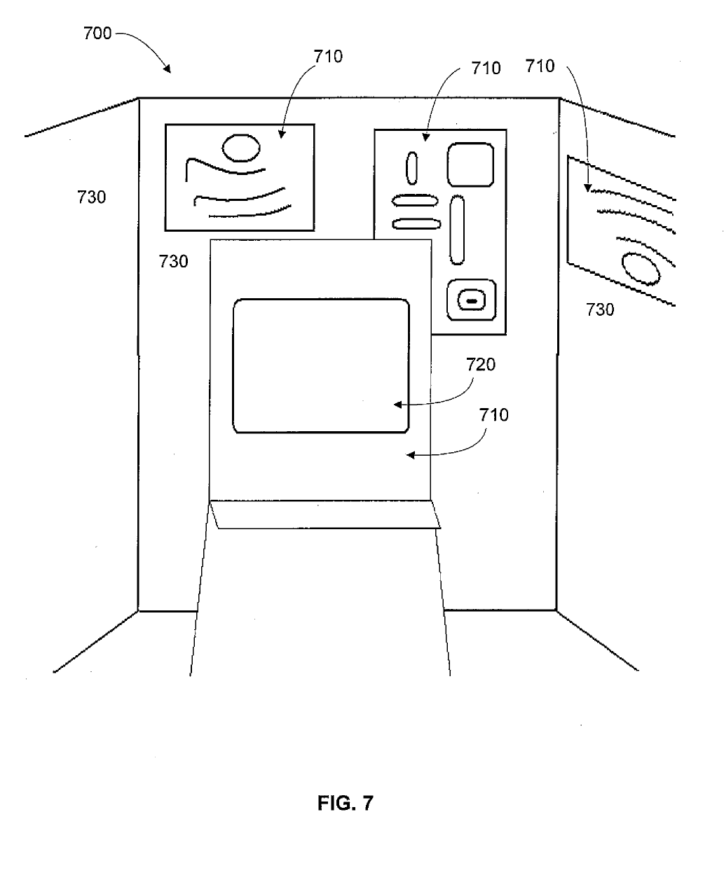

FIG. 7 illustrates one embodiment of apparatus 700 for creating customized color artwork in a retail setting, which includes display 710, computer interface 720 (which may include a touch screen) with specially enabled user menu options including but not limited to features for receiving a user image selection, receiving one or more color selections, creating an updated user interface showing an updated user image, receiving user selections for mounting and framing, receiving user confirmation, entering user identifying information and receiving tracking requests or any other step of Method 100 identified supra. Apparatus 700 may further include one or more display surfaces 730 for displaying samples of customized user images. 740, including samples of one or more framing and mounting options. Other embodiments of FIG. 7 may include optional input device 750, which may include but is not limited to a keyboard, mouse or pointing device, graphics tablet as a component of user interface or device capable of receiving user input. In the embodiment shown, the display 710 is configured to have the appearance of an artist's easel with a flat screen user interface 720, and display surfaces are designed to give the appearance of an art studio or museum. In other embodiments, display apparatus may have an alternative design, or may be of a dimension to fit within a retail space, booth or kiosk, and may have additional visual elements such as illumination. In other embodiments display 710 may be configured for use or participation by sales associates or personnel.

1. A method for creating customized artwork for a customer at a point of purchase comprised of:
creating at least one layered image to be included in a database of images capable of being displayed on a user interface;
associating each of said layered images with a plurality of image categories from which a user may select an image at point-of-purchase;
associating at least one layer in said layered image with options said user may select on said user interface;
receiving a user selection and updating said user interface to display a customized user image; and
receiving user input as to canvas used to create customized artwork.

2. The method of claim 1 which further includes the step of displaying at least one swatch below said at least one layered image, said swatch representing at least one color within a image layer, and associating said at least one swatch with a color palette.

3. The method of claim 2 which further includes the step of receiving a user selection of a color associated with said color palette which is used to modify said image layer within said customized artwork and display an updated user interface.

4. The method of claim 1 which further includes the step of updating said user interface to reflect said user selection and allowing said user to further modify said updated customized artwork.

5. The method of claim 1 wherein said layered image includes at least one adjustable layer and at least one permanent layer.

6. The method of claim 1 which further includes the step of optimizing a color palette after a first color selection to create an optimized color palette.

7. The method of claim 6 which further includes re-optimizing said optimized color palette after each subsequent color selection made after said first color selection.

8. The method of claim 1 which further includes displaying a menu of effects, receiving at least one user selected effect and updating said customized artwork to reflect said at least one user selected effect.

9. The method of claim 8 which further includes associating a price with said user selected effect.

10. The method of claim 1 which further includes the step of displaying at least one canvas option and receiving a user selection of at least one canvas option.

11. The method of claim 10, which further includes the step of associating a price with each of said at least one canvas option.

12. The method of claim 10, which further includes the step of updating a user interface to display a selected canvas option.

13. The method of claim 1, which further includes the step of displaying a user menu of at least one framing option and receiving a user selection of said at least one framing option.

14. The method of claim 13, which further includes the step of updating a user interface to display said selected framing option.

15. The method of claim 13, which further includes the step of associating at least one price with each of said at least one framing option.

16. The method of claim 1, which further includes the step of associating a user selected size with said customized artwork.

17. The method of claim 1, which further includes associating a user-selected orientation with said customized artwork.

18. The method of claim 1, which further includes the step of calculating and displaying a price with said customized artwork based on price factors selected from a group of factors consisting of size, orientation, effects, color scheme, shipping, framing, canvas selections, and overhead costs.

19. The method of claim 1, which further includes the step of allocating revenue received for said customized artwork to one or more revenue recipients.

20. The method of claim 1, which includes changing one or more adjustable layers using a menu of color scheme options.

21. A method and apparatus for creating customized artwork for a customer at a point of purchase comprising:
creating at least one layered image to be included in a database of images capable of being displayed on a user interface;
associating each of said layered images with a plurality of image categories from which a user may select an image at point-of-purchase;
associating at least one layer in said layered image with options said user may select on said user interface;
receiving a user selection and updating said user interface to display a customized user image;
receiving user input as to a canvas used to create customized artwork;
receiving user input as to features selected from a group consisting of size, orientation, effects, shipping, color scheme and colors within adjustable layers;
updating said user interface displaying said customized artwork at said point-of-purchase;
calculating payment for said customized artwork at said point of purchase;
and recording and tracking user information

22. The method of claim 1 which further includes the step of displaying at least one swatch below said at least one layered image, said swatch representing at least one color within an image layer, and associating said at least one swatch with a color palette.

23. An apparatus for creating customized artwork for a customer at a point of purchase comprising:
a user interface adapted to be displayed at said point-of-purchase capable of displaying and receiving user input relating to factors for purchasing customized artwork selected from a group consisting of color scheme selection, color options for adjustable layers, size, orientation, price range, category, canvas type and effects; and
a display for said user interface which may be adapted to display representations of customized artwork corresponding to said user input at said point of purchase, said representations consisting of a group comprising samples of framed customized artwork, samples of mounted customized artwork, photographs of customized artwork and videos of customized artwork.
